(19) United States
(12) Patent Application Publication
(10) Pub. No.: US 2011/0084095 A1
(43) Pub. Date: Apr. 14, 2011

(54) WATER DISPENSING DEVICE

(75) Inventor: Ta Chun Peng, Taichung County (TW)

(73) Assignee: GUARDER INDUSTRIAL CO., LTD., Taichung County (TW)

(21) Appl. No.: 12/577,727

(22) Filed: Oct. 13, 2009

(51) Int. Cl. B67D 7/80

(52) U.S. Cl. 222/146.1

(57) ABSTRACT

A water dispensing device includes a main tank which has a water intake disposed thereon for adopted to connect to an outer water supply. The main tank has a diverting hole defined therein. A first water valve is disposed in the diverting hole. A second tank is received in the main tank. The second tank has a water inlet defined therein. The water inlet is connected to the diverting hole such that water stored in the main tank flow from the second tank to the water inlet. A second water valve is disposed on the water inlet and abutted against the first water valve to abut against the first water valve for communicating the water inlet with the first water valve.

### BACKGROUND OF THE INVENTION

1. Field of the Invention

The present invention relates to a water dispensing device, and more particularly, to a water dispensing device adapted to connect with a water treatment device.

2. Description of Related Art

Except for some advanced countries that provide drinkable tap water, most households throughout the worldwide rely on water purification or water filtering devices to acquire drinkable water, moreover, some households would even require a second water treatment process in order to guarantee the quality of the drinking water. The common water treatment devices on the market include: water filtering devices, water purification device, reverse-osmosis (RO) purifying systems . . . etc.

However, the aforementioned drinking water treatment devices have one common disadvantage, due to the tap water has to go through many different purifying processes in the water treatment devices before it is drinkable, the outflow volume of the water is often very small, when instantly requiring a large volume of water, the small outflow from the water intake can not suffice the instant need of the volume required.

To obviate the abovementioned disadvantage, a conventional way is to install a high-pressure water storage device to the water tank and connect the water storage device with an electric water pump to instantly provide adequate supply volume of water. However, applying this conventional method not only requires considerable costs on the device, but also a lot of energy/electricity are consumed throughout the purifying processes.

In view of the disadvantages of the conventional water treatment devices, the present invention has arisen for adapting to the storage device and/or intake of the water purifying/treatment devices having small outflow of water, allowing user to acquire the desired water volume within a short period of time.

### SUMMARY OF THE INVENTION

The main objective of the present invention is to provide an improved water dispensing device.

To achieve the objective, a water dispensing device in accordance with the present invention comprises a main tank having a water intake disposed thereon for adapting to connect to an outer water supply. The main tank has a diverting hole defined therein. A first water valve is disposed in the diverting hole. A second tank is received in the main tank. The second tank has a water inlet defined therein. The water inlet is connected to the diverting hole such that water stored in the main tank flow from the second tank to the water inlet. A second water valve is disposed on the water inlet and abutted against the first water valve to abut against the first water valve for communicating the water inlet with the first water valve. The main tank is U-shape. Two water storage tanks are vertically disposed on two ends of the U-shape. An installing space is formed in between the two water storage tanks. The diverting hole is defined in a bottom of the installing space and communicated with the installing space. The water intake is disposed on one of the two water storage tanks. A water level detecting valve is mounted on the water intake for controlling the opening and closing of the water intake. A water discharge outlet is disposed on a bottom of the main tank. A water faucet is mounted to the water discharge outlet. One side of the second tank has a gripping portion extending therefrom for gripping purpose. The gripping portion has two gripping grooves respectively defined in two sides thereof for providing to be gripped by fingers. A top of the second tank has an opening defined therein. The main tank is a water dispenser which has a heating and cooling apparatus.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view to show the water dispensing unit in accordance with the present invention;

FIG. 2 is a perspective view to show the water dispensing unit in accordance with the present invention;

FIG. 3 is an assembled perspective view to show the water dispensing unit in accordance with the present invention;

FIG. 4 is a cross sectional view to show the second water valve abut against the first water valve in accordance with the present invention;

FIG. 5 is a cross sectional view to show the first water valve and the second water valve in accordance with the present invention;

FIG. 6 is a cross sectional view to show that the main tank and the second tank filled with water in accordance with the present invention;

FIG. 7 is a perspective view to show that the main tank is a water dispenser;

FIG. 8 is a perspective view of a second embodiment of a water dispensing unit in accordance with the present invention; and

FIG. 9 is an assembled perspective view of the second embodiment of a water dispensing unit in accordance with the present invention.

### DETAILED DESCRIPTION OF THE INVENTION

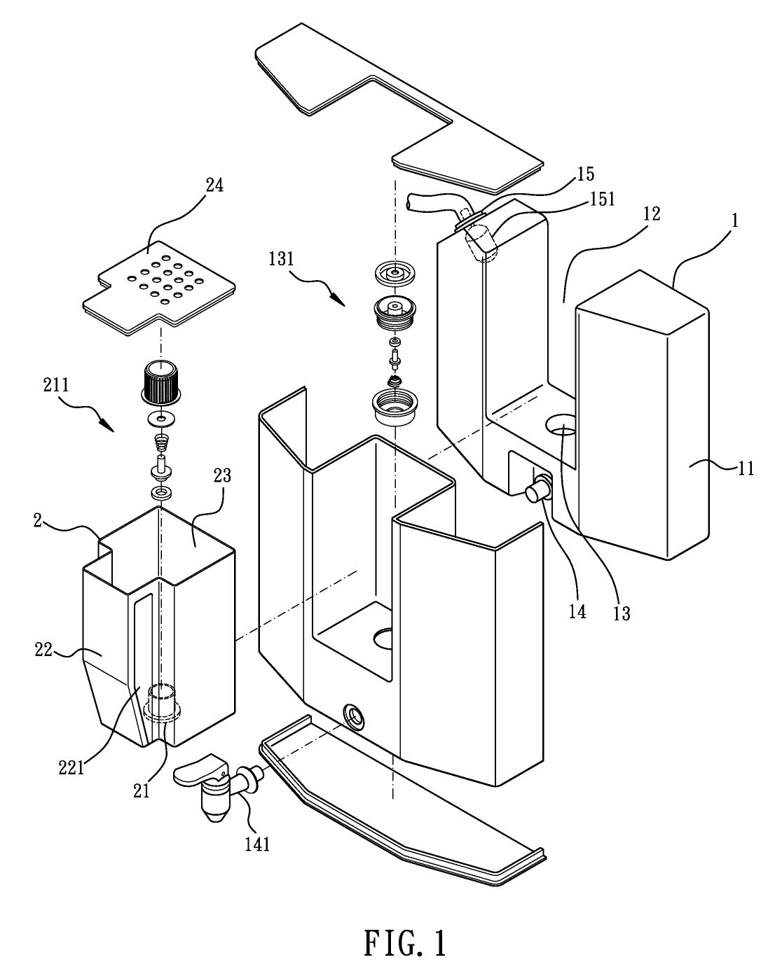

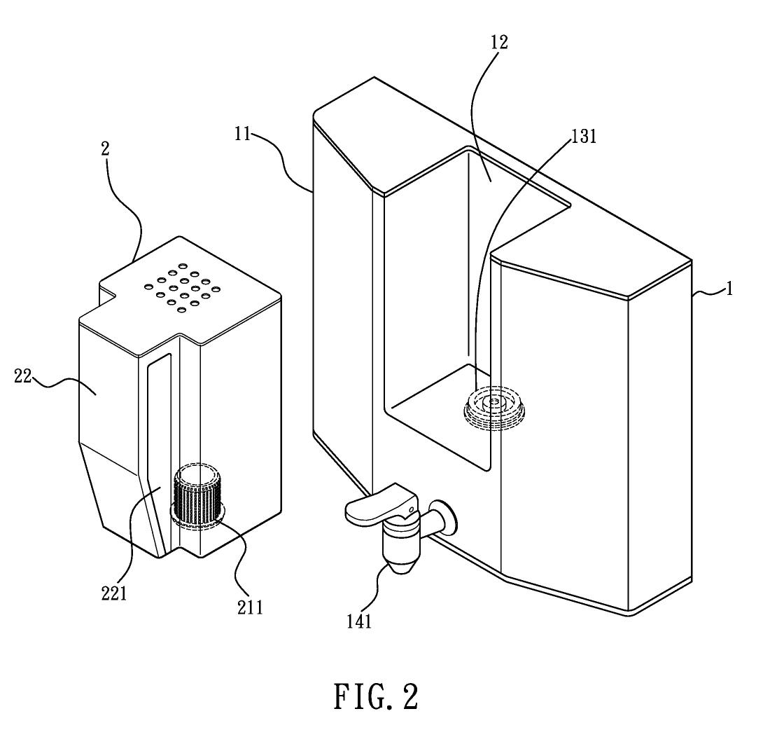

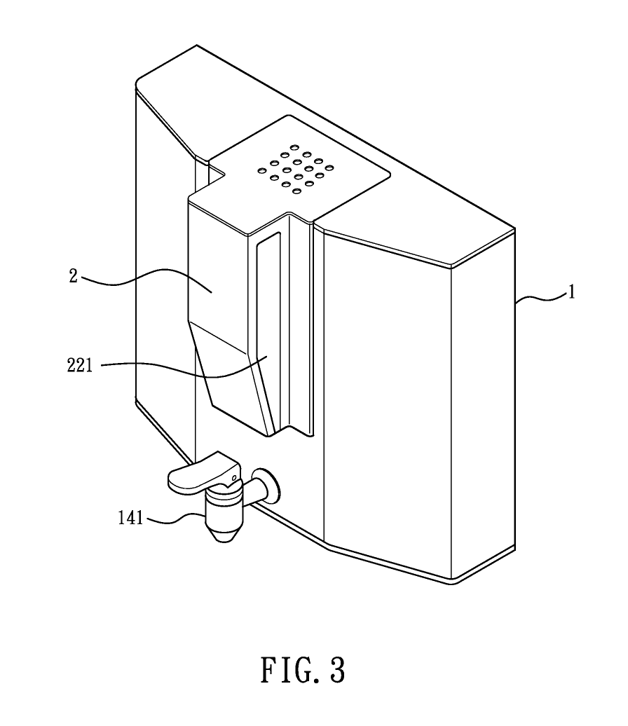

Referring to FIGS. 1 to 3, a water dispensing device in accordance with the present invention comprises a main tank 1 and a second tank 2 received in the main tank 1. The main tank 1 has two higher ends and a lower middle portion forming the main tank 1 to a U-shape. Two water storage tanks 11 are vertically disposed on two ends of the U-shape. An installing space 12 is formed on the lower middle portion of the main tank 1 and in between the two water storage tanks 11. The main tank 1 has a diverting hole 13 defined in a bottom of the installing space 12 and communicated with the installing space 12. A first water valve 131 is disposed in the diverting hole 13. A water discharge outlet 14 is disposed on a bottom of the main tank 1. A water faucet 141 is mounted to the water discharge outlet 14.

A water intake 15 is disposed on one of the two water storage tanks 11 for adapting to connect to an outer water supply. A water level detecting valve 151 is mounted on the water intake 15 for controlling the opening and closing of the water intake 15 to limit the maximum water level of the main tank 1 to avoid water overflows from the main tank 1.

The second tank 2 has a water inlet 21 defined in a bottom thereof. A second water valve 211 is disposed on the water inlet 21 and abutted against the first water valve 131 for communicating the water inlet 21 with the first water valve 131. One side of the second tank 2 has a gripping portion 22 extending therefrom for gripping purpose. The gripping portion 22 has two gripping grooves 221 respectively defined in two sides thereof for providing to be gripped by fingers. A top of the second tank 2 has an opening 23 defined therein for water stored in the second tank 2 can be easily poured out therefrom. A cover 24 is disposed on top of the opening 23. The cover 24 has a plurality of holes defined therein for the chlorine remained in the water stored in the second tank 2 to be vaporized naturally through the plurality of holes.

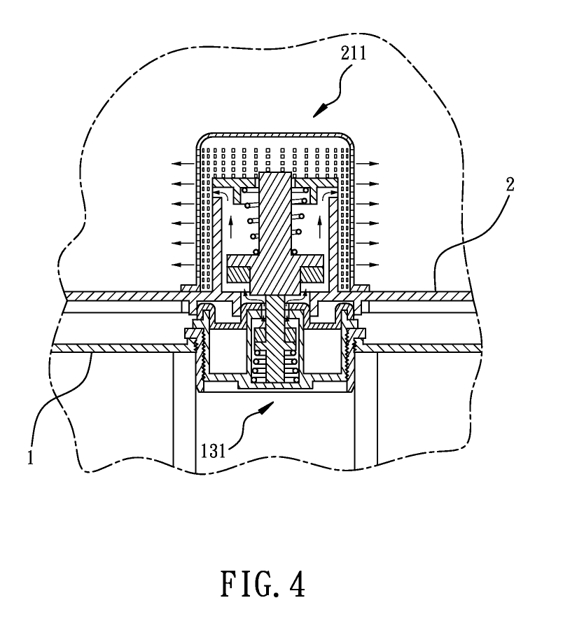

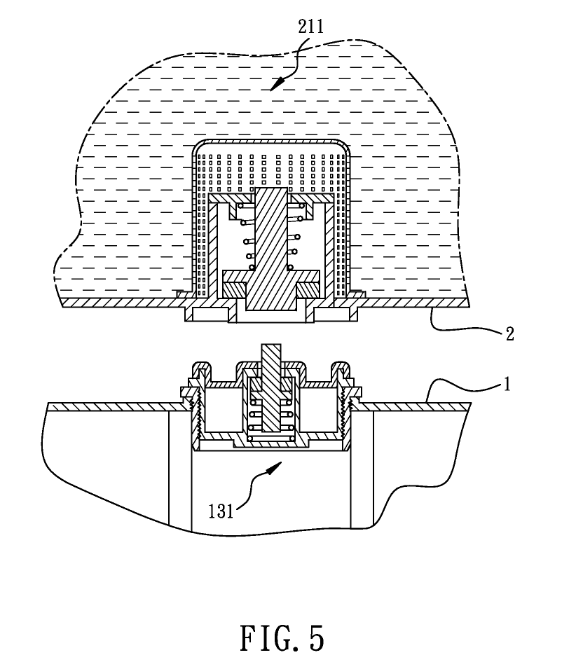

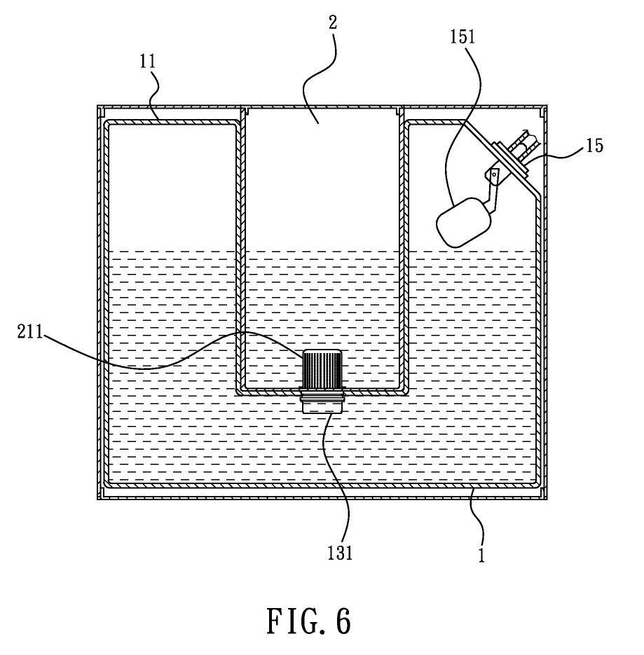

Referring to FIGS. 4-6, the second tank 2 is received in the installing space 12 of the main tank 1. The first water valve 131 and the second water valve 211 are abutted against each other such that the main tank 1 and the second tank 2 are communicated for the water stored in the main tank 1 can flow to the second tank 2.

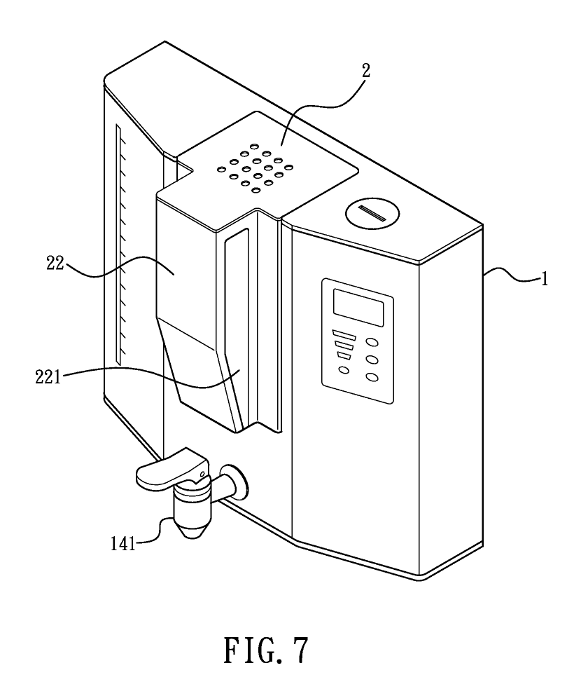

Referring to FIG. 7, the main tank 1 has a heating and cooling apparatus such that the main tank 1 is applied as a water dispenser.

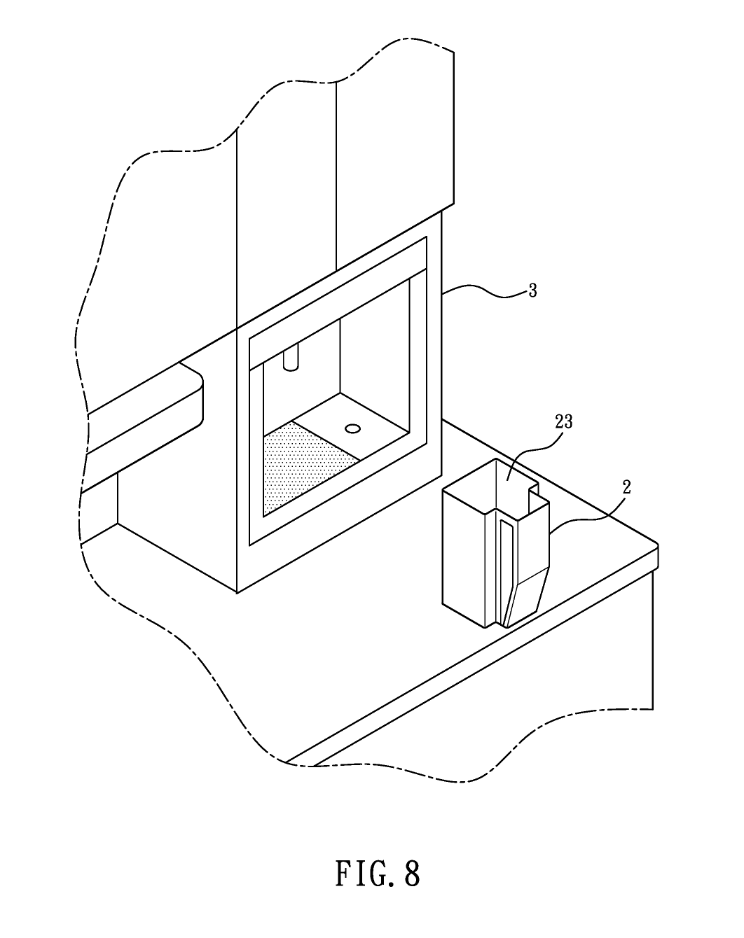

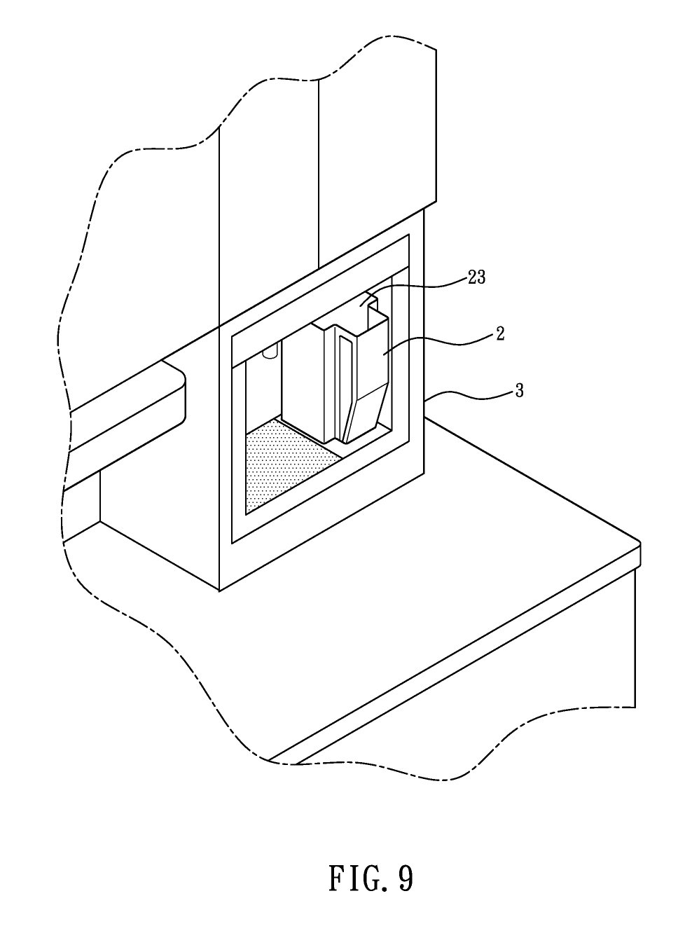

Referring to FIGS. 8-9, a second embodiment of the present invention is designed to be embedded and/or adapted to various types of water treatment devices. A tank of the water treatment device is applied as a main tank 3. The main tank 3 likewise has a diverting outlet (not numbered) mounted thereon to connect with the second tank 2.

Although the invention has been explained in relation to its preferred embodiment, it is to be understood that many other possible modifications and variations can be made without departing from the spirit and scope of the invention as hereinafter claimed.

What is claimed is:

1. A water dispensing device comprising:
a main tank having a water intake disposed thereon for adapting to connect to an outer water supply, and the main tank having a diverting hole defined therein; a first water valve disposed in the diverting hole;
a second tank received in the main tank, the second tank having a water inlet defined therein, the water inlet connected to the diverting hole such that water stored in the main tank flow from the second tank to the water inlet; a second water valve disposed on the water inlet and abutted against the first water valve to abut against the first water valve for communicating the water inlet with the first water valve.

2. The water dispensing device as claimed in claim 1, wherein the main tank is U-shape, two water storage tanks vertically disposed on two ends of the U-shape, an installing space formed in between the two water storage tanks,
the diverting hole defined in a bottom of the installing space and communicated with the installing space, the water intake disposed on one of the two water storage tanks.

3. The water dispensing device as claimed in claim 1 further comprising a water level detecting valve mounted on the water intake for controlling the opening and closing of the water intake.

4. The water dispensing device as claimed in claim 1, further comprising a water discharge outlet disposed on a bottom of the main tank, a water faucet mounted to the water discharge outlet.

5. The water dispensing device as claimed in claim 1, wherein one side of the second tank has a gripping portion extending therefrom for gripping purpose, the gripping portion having two gripping grooves respectively defined in two sides thereof for providing to be gripped by fingers.

6. The water dispensing device as claimed in claim 1, wherein a top of the second tank having an opening defined therein.

7. The water dispensing device as claimed in claim 1, wherein the main tank is a water dispenser having a heating and cooling apparatus.
